(19) United States
(12) Patent Application Publication
(10) Pub. No.: US 2013/0169764 A1
(43) Pub. Date: Jul. 4, 2013

(54) LED STEREOSCOPIC DISPLAY, DISPLAY METHOD THEREOF AND SIGNAL RECEIVER

(71) Applicants: Changjun Lu, Beijing (CN); Tong Pan, Beijing (CN)

(72) Inventors: Changjun Lu, Beijing (CN); Tong Pan, Beijing (CN)

(73) Assignee: LEYARD OPTOELECTRONIC CO, LTD., Beijing (CN)

(21) Appl. No.: 13/821,751

(22) PCT Filed: Jul. 14, 2011
(86) PCT No.: PCT/CN11/77163

§ 371 Date: Mar. 8, 2013

(30) Foreign Application Priority Data
Sep. 8, 2010 (CN) 201010275713.0

(51) Int. Cl. H04N 13/04

(52) U.S. Cl. CPC H04N 13/0452
USPC 348/51

(57) ABSTRACT

The disclosure discloses an LED stereoscopic display, a display method thereof and a signal receiver. Wherein, the LED stereoscopic display method comprises: a video signal controller, which is configured for receiving image data, and controlling the signal receiver to a single-frame mode or a double-frame mode according to the image data; a signal receiver, which is configured for receiving the image data from the video signal controller, and when in the double-frame mode, dividing the image data into left-eye image frames and right-eye image frames with a time difference there-between, and storing the left-eye image frames and the right-eye image frames; and an LED display panel, which is configured for displaying the left-eye image frames and the right-eye image frames. The disclosure can improve the resolution of the LED stereoscopic display.

### TECHNICAL FIELD OF THE INVENTION

The application relates to a Light-Emitting Diode (LED) stereoscopic display, a display method thereof and a signal receiver.

### BACKGROUND OF THE INVENTION

When Liquid Crystal Display (LCD) panel televisions or LED backlight televisions realize 3-dimensional (3D) stereoscopic image, the technologies are always adopted depending on the level of the refresh rate thereof; but the refresh rate cannot be extremely high because of the material thereof; so when realizing the 3D display, the display result may have partial edge flashing and blur phenomenon. Meanwhile, as the stereoscopic display may have data loss, the resolution may be deteriorated.

Aiming at the problem that the LED stereoscopic display has a relatively low resolution in the related technologies, no effective solution has been proposed at present.

### SUMMARY OF THE INVENTION

Example embodiments of the present invention are provided aiming at the problem that the LED stereoscopic display has a relatively low resolution in the related technologies, therefore, the main purpose of the disclosure is to provide an LED stereoscopic display, a display method thereof and a signal receiver, so as to solve the above problem.

In order to realize the above purpose, an LED stereoscopic display method is provided according to one aspect of the disclosure. The LED stereoscopic display method comprises a video signal controller, a signal receiver and an LED display panel, wherein: the video signal controller is configured for receiving the image data, and controlling the signal receiver's mode as a single-frame mode or a double-frame mode according to the image data; the signal receiver is configured for receiving the image data from the video signal controller, and dividing the image data into the left-eye image frames and right-eye image frames with a time difference when in the double-frame mode, and storing the left-eye image frames and the right-eye image frames; and the LED display panel is configured for displaying the left-eye image frames and the right-eye image frames.

In order to realize the above purpose, an LED stereoscopic display system is provided according to another aspect of the disclosure. The LED stereoscopic display system comprises any one of the LED stereoscopic display method and the stereoscopic video signal imaging glasses, wherein, the stereoscopic video signal imaging glasses are configured for receiving the images from the LED stereoscopic display method.

The disclosure adopts the LED stereoscopic display method, comprising the following structure: a video signal controller, for receiving the image data, and controlling the signal receiver as a single-frame mode or a double-frame mode according to the image date; a signal receiver, for receiving the image data from the video signal controller, and dividing the image data into the left-eye image frames and right-eye image frames with a time difference when in the double-frame mode, and storing the left-eye image frames and the right-eye image frames; and an LED display panel, for displaying the left-eye image frames and the right-eye image frames; thus, the problem that the LED stereoscopic display has a relatively low resolution in the related technologies is solved, and the effect of improving the LED stereoscopic display resolution can be achieved.

### BRIEF DESCRIPTION OF THE DRAWINGS

The drawings illustrated here provide a further understanding of the present invention and form a part of the present application. The exemplary embodiments and the description thereof are used to explain the present invention without unduly limiting the scope of the present invention. In the drawings:

FIG. 1 shows a diagram of an LED stereoscopic display method according to an embodiment of the disclosure;

FIG. 2 shows a diagram of a preferred embodiment of the LED stereoscopic display method according to the disclosure;

FIG. 3 shows a diagram of an LED stereoscopic display system according to an embodiment of the disclosure;

FIG. 4 shows a diagram of a preferred embodiment of the LED stereoscopic display system according to the disclosure;

FIG. 5 shows a flowchart of the LED stereoscopic display method according to the embodiment of the disclosure;

FIG. 6 shows a flowchart of the preferred embodiment of the LED stereoscopic display method according to the disclosure; and

FIG. 7 shows a diagram of a signal receiver according to the embodiment of the disclosure.

### DETAILED DESCRIPTION OF THE EMBODIMENTS

It needs to note that the embodiments of the present application and the features in the embodiments can be combined with each other if there is no conflict The present invention will be described hereinafter in detail with reference to the accompanying drawings and in conjunction with embodiments.

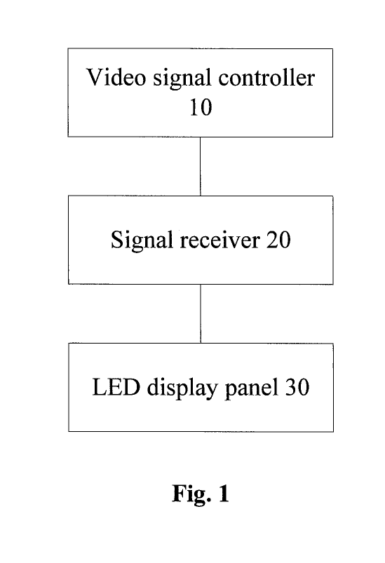

FIG. 1 shows a diagram of an LED stereoscopic display method according to an embodiment of the disclosure.

As shown in FIG. 1, the LED stereoscopic display method comprises a video signal controller 10, a signal receiver 20 and an LED display panel 30.

Wherein, the video signal controller 10 is configured for receiving the image data, and controlling the signal receiver as a single-frame mode or a double-frame mode according to the image data; the signal receiver 20 is configured for receiving the image data from the video signal controller, and dividing the image data into the left-eye image frames and the right-eye image frames with a time difference when in the double-frame mode, and storing the left-eye image frames and the right-eye image frames; the LED display panel 30 is configured for displaying the left-eye image frames and the right-eye image frames.

In the embodiment, as the signal receiver 20 stores (or caches) the 3D image data in the double-frame mode, the data loss can be prevented when implementing the stereoscopic display, and the resolution of the image display can be improved.

Preferably, the video signal controller is also configured for intercepting the image data after receiving the image data, and marking the intercepted display data as the single-frame mode or the double-frame mode, and then sending the data to the signal receiver; the signal receiver is also configured for judging the types of the display data, and dividing the display data, of which the data type is the double-frame mode, into the left-eye image frames and the right-eye image frames.

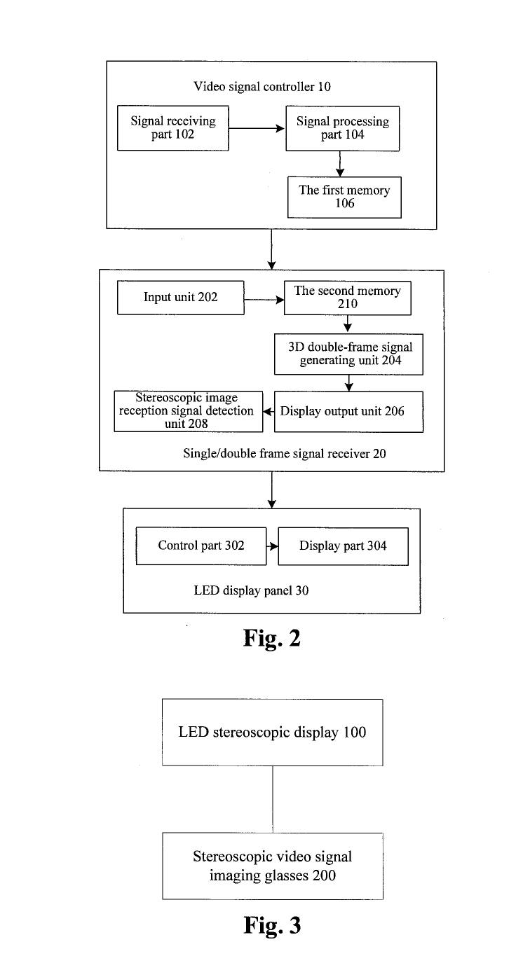

FIG. 2 shows a diagram of a preferred embodiment of the LED stereoscopic display method according to the disclosure.

As shown in FIG. 2, in the stereoscopic display of the embodiment, the video signal controller comprises a signal receiving part 102 and a signal processing part 104.

Wherein, the signal receiving part 102 is configured for receiving the image data, wherein, the image data comprises: the 2-dimensional (2D) image data, the 3D image data, the 3D image activation signal; and a signal processing part 104, which is configured for controlling the signal receiver as the single-frame mode when the image data is the 2D image data, and controlling the signal receiver as the double-frame mode when the image data is the 3D image data and comprises the 3D image activation signal.

Preferably, the signal receiver can also comprise: a first memory 106, which is connected with the signal processing part, and is configured for respectively storing the display mode with the single-frame mode and the display mode with the double-frame mode.

The signal receiver comprises an input unit 202, a second memory 210, a 3D double-frame signal generating unit 204 and a display output unit 206.

Wherein, the input unit 202 is configured for receiving the image data from the video signal controller, and dividing the image data into the left-eye image frames and the right-eye image frames; the second memory 210 is configured for storing the left-eye image frames and the right-eye image frames; the 3D double-frame signal generating unit 204 is configured for generating the 3D image frame data by alternately selecting the data of the left-eye image frames and the right-eye image frames; and the display output unit 206 is configured for outputting the 3D image frame data.

The LED display panel comprises: a display part 302 which is composed of the LED pixel matrixes; and a control part 304 which is configured for controlling the lighting of the LED pixel matrixes via scanning.

Wherein, the control part controls the lighting of the LED via scanning, and the display part is composed of the LED pixel matrixes, which can implement display according to the image data signal transmitted by the single/double-frame signal receiver, comprising 2D image display and 3D stereoscopic image display.

Preferably, the LED stereoscopic display method also comprises: a stereoscopic image reception signal detection unit 208, which is configured for detecting the signals of the stereoscopic video signal imaging glasses.

The stereoscopic image reception signal detection unit: when detecting the reception signal of the stereoscopic video signal imaging glasses, the stereoscopic image reception signal detection unit sends a 3D image display instruction to the single/double-frame signal receiver; when no reception signal of the stereoscopic video signal imaging glasses is detected, the stereoscopic image reception signal detection unit sends the 2D image display instruction to the double-frame signal receiver.

The stereoscopic image reception signal detection unit and the stereoscopic video signal imaging glasses implement two-way communication, of which the signal transmission mode is one of infrared communication, Bluetooth communication, radio frequency communication and Wireless Fidelity (Wi-Fi) communication.

FIG. 3 shows a diagram of an LED stereoscopic display system according to an embodiment of the disclosure.

As shown in FIG. 3, the LED stereoscopic display system comprises an LED stereoscopic display method and the stereoscopic video signal imaging glasses.

Wherein, the LED stereoscopic display method can be the LED stereoscopic display method of all the above embodiments. The stereoscopic video signal imaging glasses are configured for receiving the images from the LED stereoscopic display method.

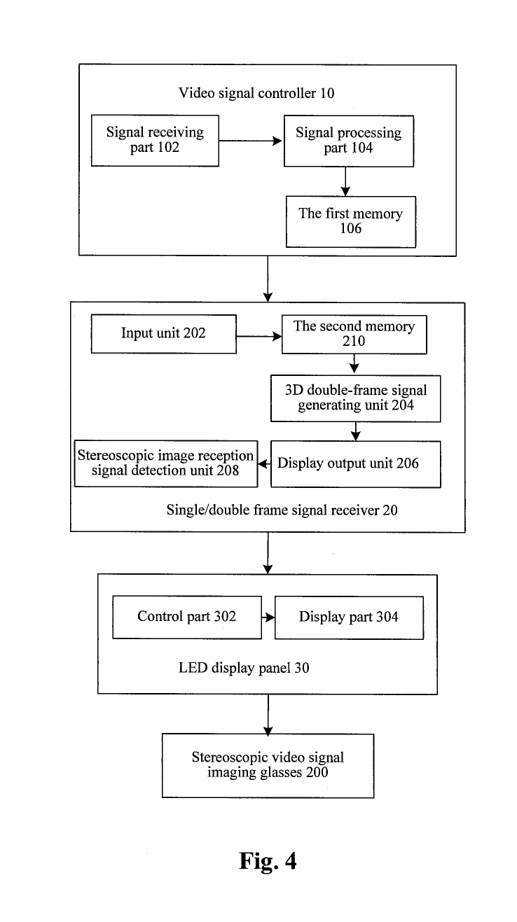

FIG. 4 shows a diagram of a preferred embodiment of the LED stereoscopic display system according to the disclosure.

As shown in FIG. 4, the LED stereoscopic display system comprises the LED stereoscopic display method according to the FIG. 2 and the stereoscopic video signal imaging glasses.

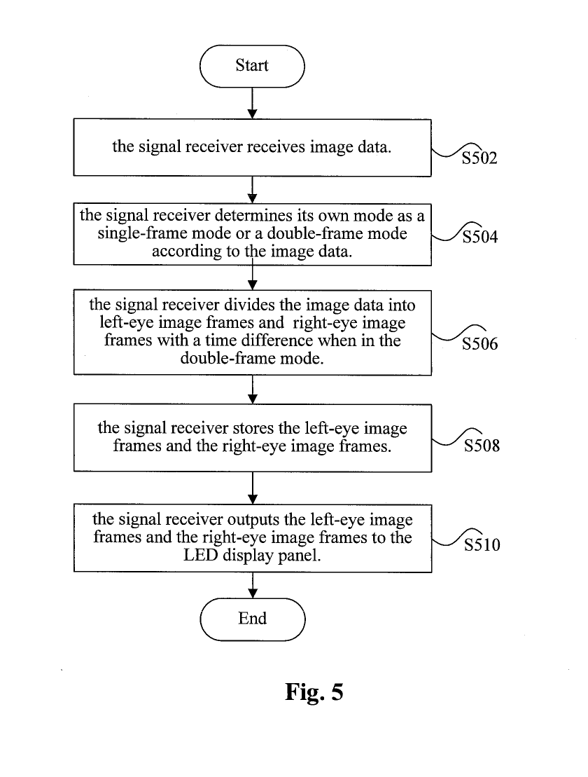

FIG. 5 shows a flowchart of the LED stereoscopic display method according to the embodiment of the disclosure. As shown in FIG. 5, the method comprises the steps below:

Step S502, the signal receiver receives the image data.

Before the signal receiver receives the image data, the method also can comprise that: the video signal controller intercepts the image data, and sends the intercepted display data to the signal receiver.

Step S504, the signal receiver determines the own mode as the single-frame mode or the double-frame mode according to the image data.

For example, the video signal controller controls the signal receiver as the single-frame mode or the double-frame mode according to the image data.

Wherein, the image data comprises the 2D image data, the 3D image data and the 3D image activation signal, preferably, the step that the video signal controller controls the signal receiver as the single-frame mode or the double-frame mode according to the image data comprises: when the image data is the 2D image data, the video signal controller controls the signal receiver as the single-frame mode; when the image data is the 3D image data and comprises the 3D image activation signal, the video signal controller controls the signal receiver as the double-frame mode.

Step S506, the signal receiver divides the image data into the left-eye image frames and the right-eye image frames with a time difference when in the double-frame mode.

Step S508, the signal receiver stores the left-eye image frames and the right-eye image frames.

Step S510, the signal receiver outputs the left-eye image frames and the right-eye image frames to the LED display panel, so that the LED display panel displays the left-eye image frames and the right-eye image frames.

The step that the signal receiver outputs the left-eye image frames and the right-eye image frames to the LED display panel can comprise: the signal receiver generates the 3D image frame data by alternately selecting the data of the left-eye image frames and the right-eye image frames; and the signal receiver outputs the 3D image frame data to the LED display panel.

Before the signal receiver outputs the left-eye image frames and the right-eye image frames to the LED display panel, the above method also can comprise: detecting whether the signals of the stereoscopic video signal imaging glasses exist; and in the case that the signals of the stereoscopic video signal imaging glasses exist, the signal receiver outputs the left-eye image frames and the right-eye image frames to the LED display panel.

After the signal receiver outputs the left-eye image frames and the right-eye image frames to the LED display panel, the method also comprises: the LED display panel displays the left-eye image frames and the right-eye image frames by controlling the lighting of the LED pixel matrixes via scanning, wherein, the display part of the LED display panel is composed of the LED pixel matrixes.

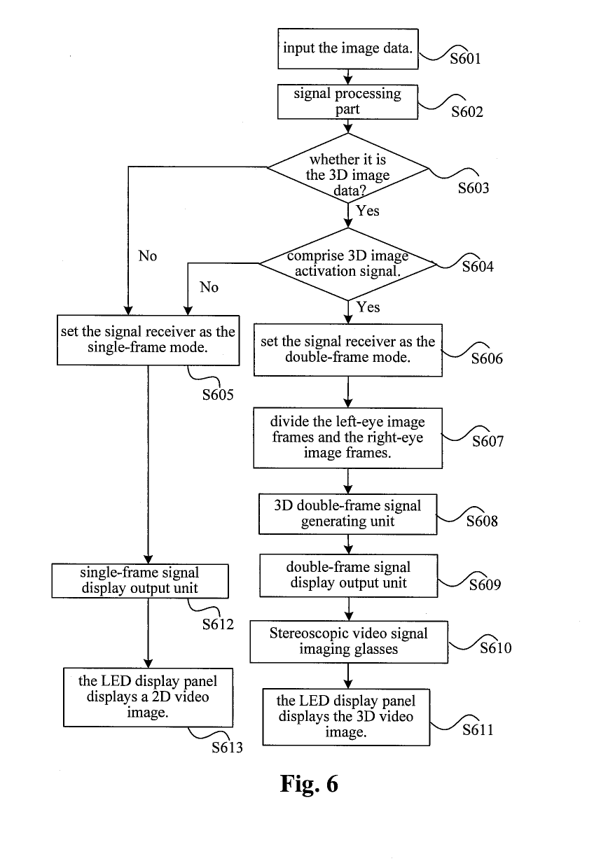

FIG. 6 shows a flowchart of the preferred embodiment of the LED stereoscopic display method according to the disclosure.

As shown in FIG. 6, the method comprises the steps below:

Step S601, inputting the image data, namely, the LED stereoscopic display method receiving the image data. Specifically, the signal receiving part of the video signal controller can receive the external image data, and this image data comprises: the 2D image data, the 3D image data and the 3D image activation signal; and transmitting the received signal to the signal processing part.

Step S602, the signal processing part processes the image data.

Step S603, judging whether the current image data is the 3D image data. If the judgement result is yes, implementing Step S604, otherwise, implementing Step S605.

Step S604, judging whether the 3D image data comprises the 3D image activation signal. If the judgement result is yes, implementing Step S606, otherwise, implementing Step S605.

Step S605, setting the signal receiver as the single-frame mode.

Step S606, setting the signal receiver as the double-frame mode.

Step S607, dividing the image frame into the left-eye frames and the right-eye image frames.

Step S608, the 3D double-frame signal generating unit: generating the 3D image frame data by alternately selecting the data of the left-eye frames and the right-eye image frames. The left-eye image frames can be input first, and the right-eye image frames can be input second; and also, the right-eye image frames can be input first, and the left-eye image frames can be input second.

Step S609, the display output unit: sending a pair of the left-eye and the right-eye image frames to the LED display panel in a time-division that one frame can be displayed and outputted. The left-eye image frames may be sent first, and then the right-eye image frames may be sent. Or, the right-eye image frames may be sent first, and the left-eye image frames may be sent after that.

Step S610, the stereoscopic video signal imaging glasses, comprising a signal trigger, which can receive the signals of the stereoscopic image reception signal detection unit, and meanwhile can select the 2D or 3D video signal imaging.

Step S611, the LED display panel displays the 3D video image.

Step S612, the single-frame signal display output unit. Under the single-frame mode, the image data is directly sent to the control part of the LED display panel.

Step S613, displaying the 2D video image on the LED display panel.

Wherein, after receiving the single 2D image data, the signal processing part intercepts the effective display data of the 2D signal, directly transmits the intercepted display data to the single/double-frequency signal receiver, and sets the signal receiver as the single-frame mode; when receiving the single 3D image data, the single processing part generates the 3D data signal to be the 2D signal, intercepts the effective display data of the 2D signal, and directly transmits the intercepted display data to the single/double-frequency signal receiver, and sets the signal receiver as the single-frame mode; when receiving the 3D image data and the 3D image activation signal, the signal processing part processes the 3D image data, intercepts the effective display data, and transmits the data to the single/double-frequency signal receiver, and sets the signal receiver as the double-frame mode.

The single/double-frame signal receiver comprises: an input unit, a 3D double-frame signal generating unit, a display output unit and a stereoscopic image reception signal detection unit.

Under the single-frame mode, directly sending the image data to the control part of the LED display panel, and displaying the 2D video image on the LED display panel.

Under the double-frame mode, entering into the input unit: receiving multiple image units output by the video signal controller, and dividing each of the image units into the left-eye image frames and the right-eye image frames with a specific time difference, storing the left-eye image frames and the right-eye image frames into the cache of the double-frame mode signal receiver.

As the principles and mechanisms of the display imaging are different, the LED solves the low frequency of the LCD, improves the brightness, and obviously improves the display colours.

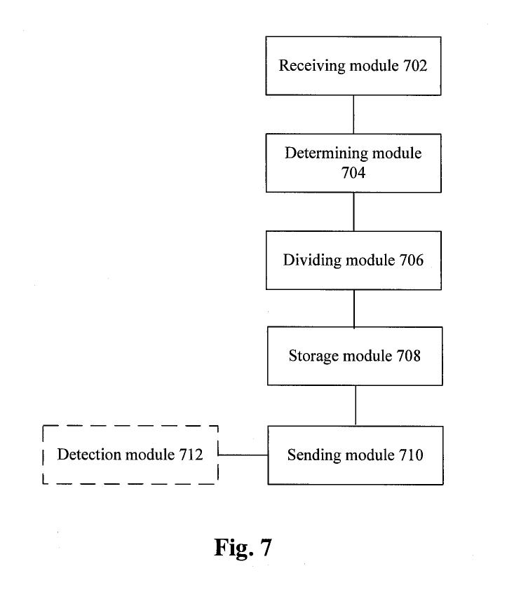

FIG. 7 shows a diagram of a signal receiver according to the embodiment of the disclosure. As shown in FIG. 7, the signal receiver comprises a receiving module 702, a determining module 704, a dividing module 706, a storage module 708 and a sending module 710.

Wherein, the receiving module 702 is configured for receiving the image data; the determining module 704 is configured for determining the own mode as the single-frame mode or the double-frame mode according to the image data; the dividing module 706 is configured for dividing the image data into the left-eye image frames and the right-eye image frames with a time difference when in the double-frame mode; the storage module 708 is configured for storing the left-eye image frames and the right-eye image frames; and the sending module 710 is configured for outputting the left-eye image frames and the right-eye image frames to the LED display panel, so that the LED display panel displays the left-eye image frames and the right-eye image frames.

Alternatively, the receiving module 702 may be the above input unit 202; the determining module 704 and the dividing module 706 may be contained in the above input unit 202, the storage module 708 may be the above second memory 210, and the sending module 710 may be the above display output unit 206.

Preferably, the signal receiver can also comprise: a detection unit 712, for detecting whether the signals of the stereoscopic video signal imaging glasses exist. The detection module 712 may be the above stereoscopic image reception signal detection unit 208.

From the above embodiments, it can be seen that the LED stereoscopic display method has the following characteristics:

1, the display panel may be fully composed of LED light sources;

2, the stereoscopic display adopts double-frame cache display;

3, the left-eye images and the right-eye images can be completely displayed, and can be transmitted in a time-division, so as to prevent data loss, and to improve the resolution.

Above description is only to illustrate the preferred embodiments but not to limit the present invention. Various alternations and changes to the present invention are apparent to those skilled in the art. The scope defined in claims shall comprise any modification, equivalent substitution and improvement within the spirit and principle of the present invention.

1. A Light-Emitting Diode (LED) stereoscopic display method, comprising:
a signal receiver receiving image data;
the signal receiver determining the own mode as a single-frame mode or a double-frame mode according to the image data;
the signal receiver dividing the image data into left-eye image frames and right-eye image frames with a time difference when in the double-frame mode;
the signal receiver storing the left-eye image frames and the right-eye image frames; and
the signal receiver outputting the left-eye image frames and the right-eye image frames to an LED display panel, so that the left-eye image frames and right-eye image frames can be displayed on the LED display panel.

2. The LED stereoscopic display method according to claim 1, wherein, before the signal receiver receiving the image data, the method further comprises:
a video signal controller intercepting the image data, and sending the intercepted image data to the signal receiver.

3. The LED stereoscopic display method according to claim 1, wherein the signal receiver determining the own mode as a single-frame mode or a double-frame mode according to the image data comprises:
a video signal controller controlling the signal receiver's mode as the single-frame mode or the double-frame mode according to the image data.

4. The LED stereoscopic display method according to claim 3, wherein the image data comprises 2D image data, 3D image data or a 3D image activation signal, wherein the video signal controller controlling the signal receiver's mode as the single-frame mode or the double-frame mode according to the image data comprises:
when the image data is the 2D image data, the video signal controller controlling the signal receiver's mode as the single-frame mode; and
when the image data is the 3D image data, and the image data comprises the 3D image activation signal, the video signal controller controlling the signal receiver's mode as the double-frame mode.

5. The LED stereoscopic display method according to claim 1, wherein, after the signal receiver outputting the left-eye image frames and the right-eye image frames to the LED display panel, the method further comprises:
the signal receiver generating a 3D image frame by alternately selecting the data of the left-eye image frames and the right-eye image frames; and
the signal receiver outputting the 3D image frame to the LED display panel.

6. The LED stereoscopic display method according to claim 1, wherein, before the signal receiver outputting the left-eye image frames and the right-eye image frames to the LED display panel, the method further comprises:
detecting whether signals of stereoscopic video signal imaging glasses exist; and
in the case that the signals of the stereoscopic video signal imaging glasses exist, the signal receiver outputting the left-eye image frames and the right-eye image frames to the LED display panel.

7. The LED stereoscopic display method according to claim 1, wherein, after the signal receiver outputting the left-eye image frames and the right-eye image frames to the LED display panel, the method further comprises:
the LED display panel displaying the left-eye image frames and the right-eye image frames by controlling lightening of LED pixel matrix via scanning, wherein a display part of the LED display panel is composed of LED pixel matrix.

8. A signal receiver, comprising:
a receiving module, configured for receiving image data;
a determining module, configured for determining the own mode as a single-frame mode or a double-frame mode according to the image data;
a dividing module, configured for dividing the image data into left-eye image frames and right-eye image frames with a time difference when in the double-frame mode;
a storage module, configured for storing the left-eye image frames and the right-eye image frames; and
a sending module, configured for outputting the left-eye image frames and the right-eye image frames to a LED display panel, so that the left-eye image frames and the right-eye image frames can be displayed on the LED display panel.

9. The signal receiver according to claim 8, further comprising:
a detection module, configured for detecting whether signals of stereoscopic video signal imaging glasses exist.

10. An LED stereoscopic display, comprising a signal receiver according to claim 8.

11. An LED stereoscopic display comprising a signal receiver according to claim 9.
